(19) United States
(12) Patent Application Publication
(10) Pub. No.: US 2002/0134313 A1
(43) Pub. Date: Sep. 26, 2002

(54) System, method, and apparatus for controlling animal feeding

(76) Inventors: Robert Andrew King, North Bethesda, MD (US); Susan Hoppe King, North Bethesda, MD (US); Floyd Brantley Chapman, Alexandria, VA (US)

Correspondence Address: Robert A. King, 10555 Tuckerman Heights Circle, North Bethesda, MD, 20852, US

(21) Appl. No.: 10/105,435

(22) Filed: Mar. 26, 2002

Related U.S. Application Data
(60) Provisional application No. 60/278,416, filed on Mar. 26, 2001.

(51) Int. Cl. A01K 1/10; A01K 5/00; A01K 39/00

(52) U.S. Cl. 119/51.02

(57) ABSTRACT

A feeding apparatus is disclosed. According to one embodiment, the feeding apparatus includes a housing that is configured to contain food. The housing includes a container for food, a moveable cover to control access to the container for food, said moveable cover being configured to move in at least i) a closed position to preclude access to the container for food, and ii) an open position to permit access to the container for food, a sensor that detects at least one identification device, and a controller that controls movement of the moveable cover. The controller causes the moveable cover to the open position in response to the detection of an authorized identification device. A method for controlling access to a feeding apparatus is disclosed. According to one embodiment of the present invention, the method includes the steps of (1) sensing a presence of a first animal through the use of an identification device; (2) determining if the first animal is an authorized user; (3) determining if one or more over-ride conditions are met; (4) and if no over-ride conditions are met, opening a moveable cover to provide access to an interior of the feeding apparatus is allowed.

The present application claims priority from U.S. Provisional Patent Application Serial No. 60/278,416, filed Mar. 26, 2001, which application is incorporated herein by reference, in its entirety.

### BACKGROUND OF THE INVENTION

1. Field of the Invention

The present invention relates generally to the field of animal feeding, and, more particularly, to a system, method, and apparatus for controlling animal feeding.

2. Description of the Related Art

Animals, such as pets, are commonplace in homes throughout the world. These animals may live inside a domicile, as cats often do, or they may live outside the domicile. It is very common for multiple animals to live with a household, including different types (e.g., species) of animals, such as cats and dogs.

When multiple animals live together, unless great care is taken, it is difficult to monitor what each animal eats. For example, two animals may be fed in separate dishes, but the more aggressive animal may eat its food, and then eat the other animal's food. If left unchecked, this may lead to one animal being obese and the other animal not eating enough.

If animals are fed outside, it is difficult to ensure that the intended animal ate its food. For instance, if the desired animal is not present, it is possible that an unintended animal, such as a stray, a wild animal, etc., may eat the food. In addition, leaving the food outside provides easy access to insects.

### SUMMARY OF THE INVENTION

Therefore, a need has arisen for a system, method, and apparatus for controlling animal feeding that overcomes these and other drawbacks of the related art.

According to one embodiment, the feeding apparatus includes a housing that includes a container for food, a moveable cover to control access to the container for food, said moveable cover being configured to move in at least i) a closed position to preclude access to the container for food, and ii) an open position to permit access to the container for food, a sensor that detects at least one identification device, and a controller that controls movement of the moveable cover. The controller causes the moveable cover to the open position in response to the detection of an authorized identification device. The sensor may generate a control signal when one identification device is within a predetermined distance of the sensor, and the controller receives the control signal. The sensor may receive a signal from the at least one identification device. The signal from the identification device may include an identification code. The identification code may be programmable and may be uniquely associated with an individual animal. Either the sensor or the identification device may emit a radio frequency transmission, and the other receives the radio frequency transmission.

The feeding apparatus may also include a temperature control device that regulates a temperature of an interior of the housing. The feeding apparatus may also include a warning device that warns of a movement of the moveable cover. The warning device may include a spray device to spray a liquid to encourage any animals to move away from the moveable cover. The feeding apparatus may also include a safety device to prevent the moveable cover from closing when an object is located in its path. The feeding apparatus may also include a programmable timer which may prevents the moveable cover from moving to an open state when during a predetermined time period.

A method for controlling access at least one animal to a feeding apparatus is disclosed. According to one embodiment of the present invention, the method includes the steps of (1) sensing a presence of a first animal through the use of an identification device; (2) determining if the first animal is an authorized user; (3) determining if one or more over-ride conditions are met; (4) and if no over-ride conditions are met, opening a moveable cover to provide access to an interior of the feeding apparatus is allowed. The method may also include the step of (5) closing the moveable cover when the first animal's presence is no longer being sensed. The over-ride conditions may include a blackout period time of day wherein an animal is not permitted to eat; a flag has been set indicating that an animal has eaten within a predetermined period of time preceding the time for which access is being sought; and a presence of at least one second animal is being sensed, which at least one second animal is precluded from feeding at the same time as the first animal. The method may also include the step of (6) closing the moveable cover in response to an over-ride condition being met after the first animal has been provided with access to the feeding apparatus. The step of closing the moveable cover may include (a) activating a warning device; and (b) closing the moveable cover.

A feeding apparatus is disclosed. According to one embodiment of the present invention, the feeding apparatus includes a housing that is configured to contain food. The housing includes an area wherein food may be placed; and a moveable cover to control access to the food area, said moveable cover being configured to move in at least i) a closed position to preclude access to the food area, and ii) an open position to permit access to the food area. The apparatus further includes a sensor that receives a signal from at least one identification device, and a processor that processes information received from the sensor and determines whether the moveable cover should be in an open or closed state. The processor may be programmed to permit access to the food area only upon pre-programmed conditions. One of the preprogrammed conditions may be receipt of a signal from an authorized identification device. The processor may be programmed to permit a first animal to feed in the absence of at least one second animal.

A feeding apparatus is disclosed. According to one embodiment of the present invention, the apparatus includes a housing that is configured to contain food, and includes a fixed cover, a moveable cover interfacing with the fixed cover, a motor that drives the moveable cover, and a sensor that detects at least one identification device. An authorized identification device causes the motor to drive the moveable cover to an open position. A bowl may be provided within the housing.

The identification device may be a RF device, an IR device, a magnetic device, etc. The apparatus may include a programmable timer.

A system for controlling access to a feeding apparatus is disclosed. According to one embodiment of the present invention, the system includes a feeding apparatus that includes a fixed cover, a moveable cover interfacing with the fixed cover, a motor that drives the moveable cover, and a sensor. The system further includes at least one identification device and each identification device may have an identification code. The identification code may be programmable. The sensor reads the identification code from the identification device to determine a state of the moveable cover.

A method for controlling access to a feeding apparatus is disclosed. According to one embodiment of the present invention, the method includes the steps of (1) detecting at least one identification device with a sensor; (2) opening a moveable cover in response to the detection, whereby access to an interior of the feeding apparatus is allowed; and (3) closing the moveable cover when the at least one identification device is no longer detected, whereby access to the interior of the feeding apparatus is denied.

A method for controlling access to a feeding apparatus is disclosed. According to one embodiment of the present invention, the method includes the steps of (1) receiving an identification code from a identification device; (2) determining if the digital identification code is an authorized identification code; and (3) opening a moveable cover in response an authorized identification code, whereby access to an interior of the feeding apparatus is allowed.

An animal feeding apparatus is disclosed. According to one embodiment of the present invention, the animal feeding apparatus includes a housing that is configured to contain food, and including a fixed cover; a moveable cover interfacing with the fixed cover; a motor that drives the moveable cover; and a sensor that detects at least one identification device. An authorized identification device causes the motor to drive the moveable cover to an open position.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a is a diagram of a feeding apparatus in an open state according to one embodiment of the present invention;

FIG. 2 is a diagram of the feeding apparatus of FIG. 1 in a closed state according to one embodiment of the present invention; and

FIG. 3 a state diagram for a feeding apparatus according to one embodiment of the present invention.

### DETAILED DESCRIPTION OF THE INVENTION

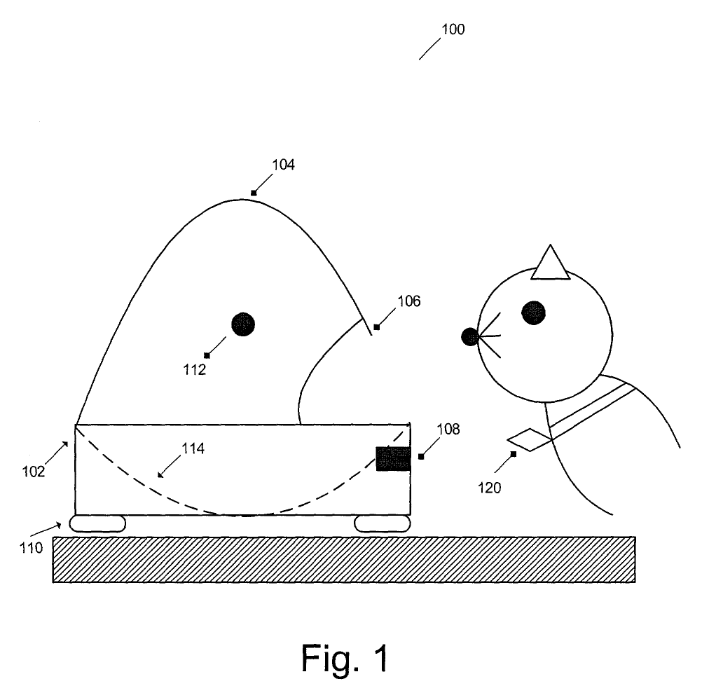

The preferred embodiment of the present invention and its advantages are best understood by referring to FIGS. 1 through 3 of the drawings, like numerals being used for like and corresponding parts of the various drawings.

Although the description of the present invention may include references to domestic animals, such as cats, dogs, potbelly pigs, guinea pigs, etc., it should be recognized that the present invention is not limited to feeding only domestic animals. The present invention may be used with a variety of animals, including animals in captivity (e.g., in a zoo), or in the wild. The present invention is in no way limited to the traditional “domesticated” animal.

Referring to FIG. 1, a diagram of a feeding apparatus according to one embodiment of the present invention is provided. According to one embodiment of the present invention, apparatus 100 includes housing 102. Housing 102 may include fixed cover 104 and moveable cover 106. Fixed cover may not move relative to housing 102. Fixed cover 104 may include an opening, such as a cut-out region, that permits access to the interior of fixed cover 104, where food (not shown) may be provided.

In one embodiment, housing 102 may be formed to include bowl 114. In yet another embodiment, housing 102 may have an open bottom and may be provided over a food source or area.

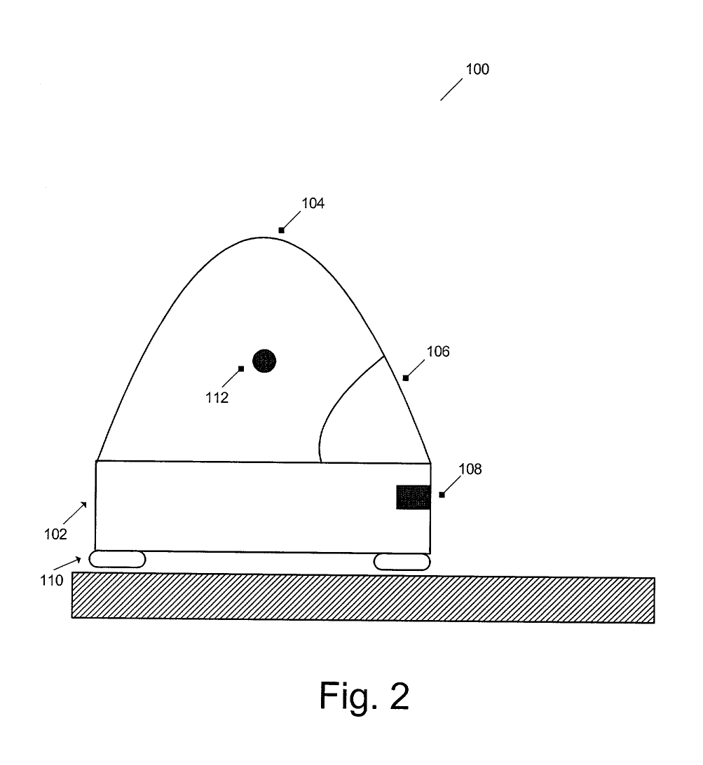

Moveable cover 106 may be provided at an interior of fixed cover 104. Moveable cover 106 may interface with fixed cover in such a manner as to slide relative to fixed cover 104. In one embodiment, shown in FIG. 1, when moveable cover 106 is open, access to the interior of housing 102 is provided. Referring to FIG. 2, when moveable cover 106 is closed, access to the interior of housing 102 is prevented. Moveable cover 106 may also slide within a pocket of fixed cover 104. In another embodiment, moveable cover 106 may consist of one element. In another embodiment, moveable cover 106 may consist of multiple elements. For example, the multiple elements may overlap when opening or closing.

Referring again to FIG. 1, moveable cover 106 may interface with the interior or exterior surface of fixed cover 104 in any suitable fashion. In one embodiment, moveable cover 106 may pivot on at least one pivot point 112. In another embodiment, at least one guide (not shown) may be provided on the interior surface of fixed cover 104. Other interactions are within the contemplation of the present invention.

Moveable cover 106 may be driven between its open (FIG. 1) and closed (FIG. 2) position by a motor (not shown). The motor (not shown) may interface and drive moveable cover 106 in a manner known in the art.

In another embodiment, instead of a moveable cover and a fixed cover, only a moveable cover may be provided for housing 102. In this embodiment, the cover would move between at least an open position and a closed position. This cover may consist of a single element, or it may consist of multiple elements which interact. For example, the two elements may slide apart, may retract in an accordion-like fashion, etc.

In still another embodiment, rather than the moveable cover move between an open and a closed position, the container containing food may move. For example, a food bowl may be caused to move from under the housing, and may also be caused to move back under cover of the housing. In such an embodiment, the food may be contained in a drawer that opens and closes.

In still another embodiment, the apparatus may be built into a structure, such as a wall. The apparatus may be used to allow for an animal to enter the apparatus; however, it is preferable that a moveable cover move to allow restricted access to an interior space where food may be stored. Should access to the entire apparatus be granted, it is desirable to include a mechanism to encourage the animal to exit the apparatus after predetermined time. Mechanisms, discussed below as warning devices, may be employed within the apparatus to encourage such behavior.

Housing 102 may include supports, or feet 110, that may provide non-skid contact with a surface, such as a floor. In one embodiment, supports 110 may be made of rubber.

Housing 102 may provide an area for electronics, such as sensor 108, processor (not shown), motor (not shown), and power supply (not shown). These items may be located within the periphery of housing 102. In another embodiment, electronics may be located in other areas of apparatus 100.

In one embodiment, housing 102, fixed cover 104, and moveable cover 106 may be shaped and/or oriented in such a manner to reduce the likelihood that the extremities of an animal are caught during movement of moveable cover 106. For example, if the housing were configured to include a container that is exactly the shape of the standard can of pet food, the cylinder-like wall may create an edge that could catch a pet's paw or claw. Whereas, if the housing were configured to include a food container that has a smooth concave area for housing food, the concave area provides no lateral edge for a pet to hang its claw (so to speak), and therefore, minimizes the risk of injury to the pet.

In one embodiment, apparatus 100 may include a temperature control device (not shown), such as a heating device or a cooling device. Such temperature device may be used to control the temperature of the interior of housing 102.

As discussed above, housing 102 may be provided with sensor 108. Sensor 108 detects the presence of at least one identification device 120, which may be worn by an animal (for example, attached by a collar around the neck of the animal). Alternatively, identification device 120 may be implanted in the animal. Identification device 120 may also attached to the animal in the same manner as an identification tag. This may be particularly desirable if the present invention is used in a zoo, or in the wild. Sensor 108 and identification device 120 may communicate by a variety of means. In one embodiment, sensor 108 and identification device 120 may communicate by radio-frequency. In another embodiment, sensor 108 and identification device 120 may communicate via infra-red (IR). In another embodiment, sensor 108 may be an inductance sensor. In still another embodiment, sensor 108 may be a magnetic sensor. Other types of sensors are within the contemplation of the present invention.

In one embodiment, identification device 120 is small and lightweight, and does not interfere with the animal's movement. Identification device 120 may be a low-power device, or it may be a passive device.

In another embodiment, identification device 120 may be a passive RF device. In another embodiment, a “smart card” may be reduced in size to be worn by an animal. Smart cards, which are known in the art, can include an embedded computer chip having processing power and memory. Variants of these cards were described in the early 1970s by, for example, Moreno in U.S. Pat. No. 4,007,355, the disclosure of which is incorporated by reference in its entirety. Other “smart card” devices, as are known in the art, may also be used.

In one embodiment, identification device 120 may be used to continuously or periodically transmit a unique identification code. The range of identification device 120 may be pre-set; and in another embodiment, the range of identification device 120 may be programmable. The range of identification device 120 may be adjusted by any suitable method, including for example, by increasing or decreasing the transmission power.

In one embodiment, sensor 108 may be able to identify identification device 120 as identification device 120 approaches sensor 108. For example, this would occur as an animal wearing identification device approaches apparatus 100. As the animal comes with a predetermined range of apparatus 100, sensor 108 may receive a signal emitted from identification device 120, which may include a code. Apparatus 100 processes the code by comparing it with a database of predetermined or programmable authorized access codes. A database of predetermined unauthorized access codes may also be provided in advance by the retailer or manufacturer, or may be programmed by the user using a computer or other input device that are readily available.

If the code from identification device 120 is an authorized access code, the motor may cause moveable cover 104 to open, providing access to the interior of housing 102. If the code from identification device 120 is a unauthorized access code, moveable cover 104 will not open.

Apparatus 100 may be powered by a power cord (not shown) that may interface with standard AC household current. In one embodiment, a transformer may be used to step down the voltage of the standard AC. In another embodiment, apparatus 100 may be powered by batteries (not shown). In yet another embodiment, apparatus 100 may be powered by solar energy received through a solar cell (not shown) and stored in a battery (not shown).

The controller (not shown) controls the operation of apparatus 100. The controller may maintain a programmable clock for apparatus 100. The programmable clock may function such that moveable cover 106 may be prevented from moving during predetermined times. Thus, during these times, access to the interior of housing 102 may be denied.

The controller may receive information regarding any data transmitted from any identification devices 120 within the range of sensor 108. The controller may control motor (not shown) to move moveable cover 106 between its open and closed states.

The controller may also control additional devices. In one embodiment, apparatus 100 may be provided with a warning device, such as sound making device (not shown), such as a horn, a buzzer, etc., in order to indicate that moveable cover 106 is moving from its open to its closed position, or vice-versa. In another embodiment, the controller may activate a training device (not shown), such as a misting device, that sprays a small amount of water from a reservoir (not shown) near the opening of fixed cover 104 shortly before moveable cover 106 moves from its open position to its closed position. In another embodiment, flashing lights may be provided. In one embodiment, this training feature may be deactivated as desired. The controller may be provided with an interface that permits a user to interact with apparatus 100. In one embodiment, switches, buttons, etc., may be used to interface with apparatus 100. In another embodiment, the status of apparatus 100 may be provided via any suitable means, including LCD displays, LEDs, etc.

In another embodiment, a safety device that stops moveable cover 106 from closing if an object is located in the opening may be provided. Such sensors include a tape switch, electric eyes, etc. Such sensors and methods for employing them are known in the art.

In one embodiment, apparatus 100 may interface with a network (not shown) to enable a user to monitor and control apparatus 100 remotely, such as from a remote computer. In another embodiment, a user may interface with apparatus 100 through a IR port (not shown), which may be provided in addition to sensor 108. This may enable a user to control apparatus 100 via a remote control (not shown). In another embodiment, the user may control apparatus 100 with a personal digital assistant (PDA), such as the Palm®-series PDAs, manufactured by Palm, Inc., Santa Clara, Calif. Other devices, such as web-enabled phones, may be used to control apparatus 100 as desired.

In another embodiment, apparatus 100 may include a modem, allowing direct communication with apparatus via telephone lines. In such an embodiment, a user may be able to control or receive information regarding the status of apparatus 100 using a touch-tone keypad.

Apparatus 100 may include mechanisms for replenishing the supply of food or liquid. In one embodiment, apparatus 100 may include a receiver that may be connected to a liquid source, such as a water source, for replenishing or changing the liquid contents. Apparatus 100 may also include a drain (not shown) to permit a complete replacement of liquid. Apparatus 100 may also include a filtering mechanism, such as a pump and a filter (e.g., charcoal, paper, etc.) to periodically or continuously circulate and clean the liquid within.

According to another embodiment of the present invention, a state diagram of a method for controlling animal feeding according to one embodiment of the present invention is provided.

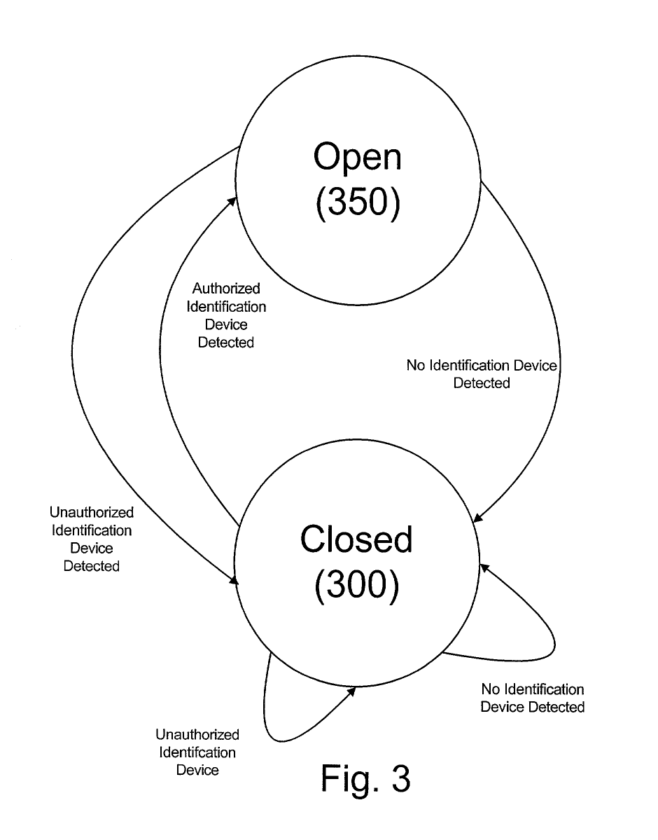

Referring to FIG. 3, two general states are provided: closed state 300, which, in one embodiment, may be the default state; and open state 350. In general, if no identification device is sensed be the apparatus, or an unauthorized identification device is sensed, the apparatus will remain in the closed state. In another embodiment, the apparatus may remain in the closed state for other reasons, such as if the apparatus has been programmed not to open at certain times of the day.

The apparatus may transition from closed state 300 to open state 350 if an authorized identification device is sensed. For example, this may happen if an animal wearing an identification device comes within range of the apparatus. In one embodiment, the identification may be programmed into the apparatus, so that the apparatus may correctly identify the identification device, and hence the animal associated therewith. In multiple animal environments, an animal may similarly be precluded from accessing the interior of the apparatus with a identification device.

The apparatus may transition from open state 350 to closed state 300 if the authorized identification device is no longer detected. An example of such is if the authorized animal leaves the area of the apparatus. The apparatus may also transition to closed state 300 if an unauthorized identification device is detected. An example of such is if an authorized animal is accessing the interior of the apparatus, and an unauthorized animal, wearing a identification device that does not possess an authorized code, approaches the apparatus. The apparatus would then transition to closed state 350 to preclude the unauthorized animal from accessing the interior of the apparatus.

Other states that are not shown are within the contemplation of the present invention. In one embodiment, the apparatus may transition from open state 350 to closed state 300 and provide an alert to the animals. This alert may include flashing lights, horns, water misting, etc. In one embodiment, this state may be used for training purposes, and may be disabled, or reduced in intensity (e.g., from water spray to a simple buzz) when the animal is properly trained.

Although the previous embodiment was discussed in conjunction with an authorized identification device, it should be noted that, in a one animal environment, there may not be a need to determine if the identification device is authorized. In such an embodiment, the apparatus may open in the presence of any identification device. In the one animal environment, the processor can be programmed to provide food on a predetermined schedule (for example, once in the morning, and once in the evening), or even to limit the feeding window (for example, ten (10) two-minute feeding sessions). Once can program the processor to permit feeding in accordance with a veterinarian's prescribed feeding schedule.

The present invention has uses in both a controlled environment, such as inside a dwelling, or in a non-controlled embodiment, such as the outdoors, or even in the wild. It may be used in single or multiple animal environments, including multi-species environments. It may be used to promote the good health of both the authorized animal, as well as the unauthorized animal. In the multi-animal environment, the processor can be programmed to provide food on a predetermined schedule (for example, once in the morning, and once in the evening), or even to limit the feeding window (for example, ten (10) two-minute feeding sessions). One can also program the processor to provide a feeding opportunity for one pet when another pet is not present. This is especially helpful for the pet owner who owns two pets, one of whom is an aggressive eater who eats not only his food, but also the food of the other pet. The processor can be programmed to permit both pets to eat on a given scheduled, but to also permit additional feeding opportunities for the non-aggressive pet (such as when the aggressive pet is not present). Because each pet wears an identification device 120 that may be uniquely identified and associated with a given pet, the sensor 108 can readily distinguish between multiple animals to provide customized feeding. Alternatively, where the identification device 120 is an RF transmitter, its transmission power may be calibrated or otherwise set to correspond to a proximity indicator such that sensor 108 will be able to tell if the wearer is within a predetermined radius of the food.

Variations on how to control the feeding of multiple animals also exist. For example, the more aggressive animal may wear an identification device that causes another apparatus to close when he approaches, but remain open at other times. This may not require the less aggressive animal to wear an identification device. In this scenario, the less aggressive animal's apparatus would remain open unless the more aggressive animal approaches.

It is also possible in such a scenario that the more aggressive animal will not need to use the apparatus of the present invention. If the goal is to provide more opportunity for the less aggressive animal to eat, there may only be a need to preserve the food for this animal, while allowing both animals unrestricted access to the more aggressive animal's food.

The present invention also has application with multiple animals of different dietary needs. For example, as animals age, it is often necessary to provide them with a special diet that may not be proper for younger animals. Similarly, younger animals, such as kittens and puppies, may require special food that is not appropriate for older animals. The present invention provides an apparatus and method for controlling access to food in these and other circumstances.

The apparatus of the present invention may vary in size depending on the type of animal to be fed. It is within the contemplation of the present invention to use the apparatus with small domestic animals (such as cats and dogs), as well as farm animals and wild animals. The present invention may be useful in a zoo environment, or even in a open range zoo where animal roam free of cages. By providing animals with identification devices, they may be able to fed the appropriate, and not fed food not intended to be for that animal.

In addition, although the embodiment described herein has a particular shape, it should be noted that such disclosed shape in no way limits the present claims. Many shapes and designs, both functional and aesthetic, are within the scope of the claims of the present invention.

Other embodiments and uses of the invention will be apparent to those skilled in the art from consideration of the specification and practice of the invention disclosed herein. All references cited herein, including all U.S. and foreign patents and patent applications, are specifically and entirely hereby incorporated herein by reference. It is intended that the specification and examples be considered exemplary only, with the true scope and spirit of the invention indicated by the following claims.

We claim:

1. A feeding apparatus, comprising:
a housing that is configured to contain food; the housing comprising:
a container for food;
a moveable cover to control access to the container for food, said moveable cover being configured to move in at least i) a closed position to preclude access to the container for food, and ii) an open position to permit access to the container for food;
a sensor that detects at least one identification device;
a controller that controls movement of the moveable cover;
wherein the controller causes the moveable cover to the open position in response to the detection of an authorized identification device.

2. The feeding apparatus of claim 1, wherein the sensor generates a control signal when the at least one identification device is within a predetermined distance of the sensor, and the controller receives the control signal.

3. The feeding apparatus of claim 1, wherein the sensor receives a signal from the at least one identification device.

4. The feeding apparatus of claim 1, wherein the signal from the at least one identification device comprises an identification code.

5. The feeding apparatus of claim 4, wherein the identification code is programmable and can be uniquely associated with an individual animal.

6. The feeding device of claim 1, wherein at least one of the sensor and the identification device emits a radio frequency transmission, and the other of the sensor and the identification device receives the radio frequency transmission.

7. The feeding apparatus of claim 1, further comprising:
a temperature control device for regulating a temperature of an interior of the housing.

8. The feeding apparatus of claim 1, further comprising:
a warning device that warns of a movement of the moveable cover.

9. The feeding apparatus of claim 8, wherein the warning device comprises:
a spray device to spray a liquid to encourage any animals to move away from the moveable cover.

10. The feeding apparatus of claim 1, further comprising:
a safety device to prevent the moveable cover from closing when an object is located in its path.

11. The feeding device of claim 1, wherein the safety device comprises safety tape that completes a circuit to provide a control signal when the safety tape is under pressure.

12. The feeding device of claim 1, further comprising a programmable timer that prevents the moveable cover from moving to an open state when during a predetermined time period.

13. A method for controlling access of at least one animal to a feeding apparatus, comprising:
sensing a presence of a first animal through the use of an identification device;
determining if the first animal is an authorized user;
determining if one or more over-ride conditions are met;
and if no over-ride conditions are met, opening a moveable cover to provide access to an interior of the feeding apparatus is allowed.

14. The method of claim 13, further comprising
closing the moveable cover when the first animal's presence is no longer being sensed.

15. The method of claim 13, wherein the over-ride conditions are selected from the group consisting of: a blackout period time of day wherein an animal is not permitted to eat; a flag has been set indicating that an animal has eaten within a predetermined period of time preceding the time for which access is being sought; and a presence of at least one second animal is being sensed, which at least one second animal is precluded from feeding at the same time as the first animal.

16. The method of claim 15, further comprising:
closing the moveable cover in response to an over-ride condition being met after the first animal has been provided with access to the feeding apparatus.

17. The method of claim 16, wherein the step of closing the moveable cover comprises:
activating a warning device; and
closing the moveable cover.

18. A feeding apparatus, comprising:
a housing that is configured to contain food; the housing comprising:
an area wherein food may be placed; and
a moveable cover to control access to the food area, said moveable cover being configured to move in at least i) a closed position to preclude access to the food area, and ii) an open position to permit access to the food area;
a sensor that receives a signal from at least one identification device;
a processor that processes information received from the sensor and determines whether the moveable cover should be in an open or closed state;
wherein the processor may be programmed to permit access to the food area only upon pre-programmed conditions.

19. The feeding apparatus of claim 18, wherein at least one of the pre-programmed conditions is receipt of a signal from an authorized identification device.

20. The feeding apparatus of claim 18, wherein the processor is programmed to permit a first animal to feed in the absence of at least one second animal.
